(19) United States
(12) Patent Application Publication
(10) Pub. No.: US 2020/0147797 A1
(43) Pub. Date: May 14, 2020

(54) REBAR AUTOMATING ROBOT

(71) Applicant: SkyMul Inc., Marietta, GA (US)

(72) Inventors: Eohan George, Marietta, GA (US); Stefan Posey, Austell, GA (US)

(21) Appl. No.: 16/679,158

(22) Filed: Nov. 9, 2019

Related U.S. Application Data
(60) Provisional application No. 62/757,765, filed on Nov. 9, 2018.

(51) Int. Cl. B25J 9/16; B25J 11/00

(52) U.S. Cl. CPC B25J 9/1679; B25J 5/005; B25J 11/005; B25J 9/1697

(57) ABSTRACT

Disclosed is a rebar automating robot for rebar tying on at least one rebar intersection. The rebar automating robot includes a control box 120 and a processing device 108. The control box 108 includes at least one intersection detection sensor 104 and at least one positioning sensor 106. The at least one intersection detection sensor 104 and the at least one positioning sensor 106 identifies a location of the at least one rebar intersection of a work area. The method include (a) navigating, the rebar automating robot to a first rebar intersection for tying the first rebar intersection, (b) tying, by a rebar tying tool, the first rebar intersection of the work area, and (c) navigating, the rebar automating robot, from the first rebar intersection to a second rebar intersection for performing rebar tying at the second rebar intersection of the work area.

### CROSS-REFERENCE TO RELATED APPLICATIONS

This application claims priority to U.S. provisional patent application No. 62/757,765 filed on Nov. 9, 2018, the non-provisional disclosure of which, in its entirety, is herein incorporated by reference.

### BACKGROUND

### Technical Field

The embodiments herein generally relate to a work area of a construction site, and more particularly, to a rebar automating robot for rebar tying at at least one rebar intersection.

### Description of the Related Art

During concrete construction, arrays of reinforcement rods are erected within forms so that when a concrete is poured, a resultant structure is strengthened by a rebar. Typically intersecting sections of the rebar are hand tied to each other with a wire. Although it has been known in the prior art to provide various types of hand tools for tying rebar, numerous challenges have existed in the past.

Conventionally, an assembly of rebar has mostly relied upon manpower, for arranging the rebar at regular intervals, after arranging the rebar in a matrix, vertical building operation to tie the rebar and a horizontal rebar, all of which are done by hand which takes a lot of manpower, also longer time for assembly.

Accordingly, there remains a need for a rebar automating robot for rebar tying at at least one rebar intersection for shorter construction time, improved quality and reduced cost of the rebar tying at the at least one rebar intersection.

### SUMMARY

In view of the foregoing, embodiments herein provide a rebar automating robot for rebar tying at at least one rebar intersection. The rebar automating robot includes a control box and a processing device. The control box includes at least one intersection detection sensor and at least one positioning sensor. The at least one intersection detection sensor and the at least one positioning sensor identifies a location of the at least one rebar intersection of a work area. The processing device is controlled by the control box to perform a method for the rebar tying at the at least one rebar intersection. The method include (a) navigating, the rebar automating robot to a first rebar intersection for tying the first rebar intersection, (b) tying, by a rebar tying tool, the first rebar intersection of the work area, and (c) navigating, the rebar automating robot, from the first rebar intersection to a second rebar intersection for performing rebar tying at the second rebar intersection of the work area.

In some embodiments, the method includes moving, by at least one of (i) a parallel style manipulator or (ii) a serial style manipulator, the rebar tying tool at the first rebar intersection, and tying, by the rebar tying tool, the first rebar intersection of the work area.

In some embodiments, the parallel style manipulator includes X, Y, and Z coordinates.

In some embodiments, the serial style manipulator includes the X, Y, and Z coordinates.

In some embodiments, at least one of (i) the parallel style manipulator or (ii) the serial style manipulator, includes a system with at least one degree of freedom.

In some embodiments, at least one of (i) the parallel style manipulator or (ii) the serial style manipulator positions the rebar tying tool with the at least one rebar intersection.

In some embodiments, the processing device analyzes data for navigating the rebar automating robot to the at least one rebar intersection. The data includes at least one of a position of rebar laid, a spacing of rebar laid, tied intersections, and intersections to tie.

In some embodiments, the rebar tying tool includes at least one of a rebar gun, a wire spool, plastic fasteners, a tie-wire reel, a rebar twist plier, an electric power tool, a Reinforcing rod binding machine, or a bar connecting apparatus.

In some embodiments, the rebar automating robot includes a ground-based robot or an air-based robot.

In some embodiments, the method includes inputting, a rebar size to the system by at least one of: the air-based robot, a technician, or from a computer-aided design and drafting CAD model.

In some embodiments, the method includes combining the rebar size and the data for determining untied and tied rebar intersections, for performing the rebar tying of an untied rebar intersection.

In one aspect, a rebar automating robot controlled method for automatic rebar tying at at least one rebar intersection is provided. The method includes (a) identifying, by at least one intersection detection sensor and at least one positioning sensor a location of the at least one rebar intersection of a work area, (b) navigating, the rebar automating robot to a first rebar intersection for tying the first rebar intersection, (c) tying, by a rebar tying tool, the first rebar intersection of the work area, and (d) navigating, the rebar automating robot, from the first rebar intersection to a second rebar intersection for performing rebar tying at the second rebar intersection of the work area.

In some embodiments, the method includes analyzing a data for navigating the rebar automating robot to the rebar intersection. The data includes at least one of: a position of rebar laid, a spacing of rebar laid, tied intersections, or intersections to tie.

In some embodiments, the parallel style manipulator includes X, Y, and Z coordinates.

In some embodiments, the serial style manipulator includes the X, Y, and Z coordinates.

In some embodiments, at least one of (i) the parallel style manipulator or (ii) the serial style manipulator, includes a system with at least one degree of freedom.

In some embodiments, at least one of (i) the parallel style manipulator or (ii) the serial style manipulator positions the rebar tying tool with the at least one rebar intersection.

In some embodiments, analyzing a data for navigating the rebar automating robot to the at least one rebar intersection. The data includes at least one of a position of rebar laid, a spacing of rebar laid, tied intersections, and intersections to tie.

In some embodiments, the method includes inputting, a rebar size to the rebar automating robot by at least one of: the air-based robot, a technician, or from a computer-aided design and drafting CAD model.

In some embodiments, the method includes combining the rebar size and the data for determining untied and tied rebar intersections, for performing the rebar tying of an untied rebar intersection.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a rebar automating robot for a rebar tying according to some embodiments herein;

FIG. 2A is a block diagram that illustrates an air-based robot for the rebar tying according to some embodiments herein;

FIG. 2B is a block diagram that illustrates a ground-based robot for the rebar tying according to some embodiments herein;

FIG. 3 illustrates an exemplary view of the ground-based robot or the air-based robot for identifying at least one rebar intersection to tie and tying the identified at least one rebar intersection according to some embodiments herein;

FIG. 4 illustrates an exemplary view of the ground-based robot or the air-based robot tying the at least one rebar intersection according to some embodiments herein;

FIG. 5 illustrates an exemplary view of the ground-based robot or the air-based robot for identifying a rebar geometry according to some embodiments herein;

FIG. 6 illustrates an exemplary view of the rebar by the ground-based robot or the air-based robot according to some embodiments herein;

FIG. 7 is a flow diagram that illustrates a method for tying a rebar according to some embodiments herein;

FIG. 8 is a flow diagram that illustrates a method of determining a rebar size and a rebar offset for tying the rebar according to some embodiments herein;

FIG. 9 is a flow diagram that illustrates a method for determining the rebar size and the rebar offset and commanding a rebar tying tool to tie a first rebar intersection according to some embodiments herein;

FIG. 10 is a flow diagram that illustrates a method for aligning the rebar tying tool at a second rebar intersection according to some embodiments herein;

FIG. 11 is a flow diagram that illustrates a method for automating the rebar according to some embodiments herein;

FIG. 12 illustrates an exemplary view of the air-based robot at a first rebar intersection according to some embodiments herein;

FIG. 13 illustrates a front view of the air-based robot according to some embodiments herein;

FIG. 14 illustrates a back view of the air-based robot according to some embodiments herein;

FIG. 15 illustrates a X and Y coordinates of a work area according to some embodiments herein; and

FIG. 16 illustrates a rebar automating robot controlled method for a rebar tying at at least one rebar intersection according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

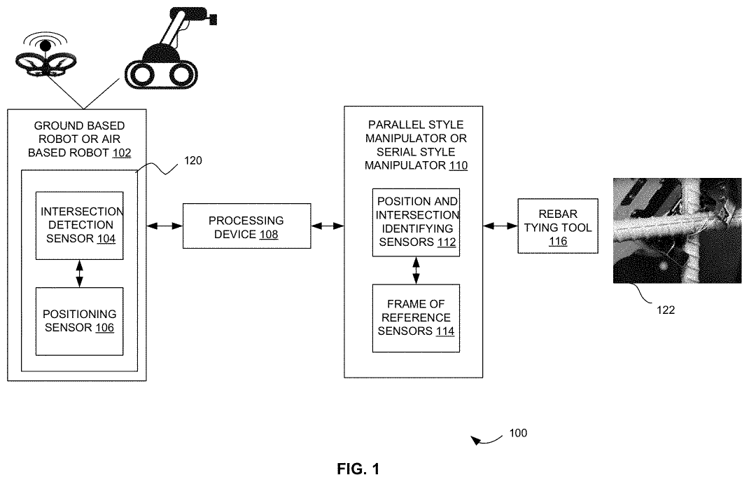

As mentioned, there remains a need for a rebar automating robot for a rebar tying at at least one rebar intersection for shorter construction time, improved quality and reduced cost of the rebar tying. The embodiments herein achieve this by identifying a geometry of placed rebar for auditing and then positioning the rebar automating robot over a work area, and identifying the at least one rebar intersection to tie and tying the at least one rebar intersection using a rebar tying tool. Referring now to the drawings, and more particularly to FIGS. 1 through 16, where similar reference characters denote corresponding features consistently throughout the figures, there are shown preferred embodiments.

FIG. 1 is a block diagram 100 that illustrates a rebar automating robot for a rebar tying according to some embodiments herein. The block diagram 100 includes a ground-based robot or an air-based robot 102, a processing device 108, at least one of (i) a parallel style manipulator or (ii) a serial style manipulator 110, and a rebar tying tool 116. The ground-based robot or the air-based robot 102 includes a control box 120. The control box 120 includes at least one intersection detection sensor 104 and at least one positioning sensor 106. In some embodiments, the at least one positioning sensor 106 include at least one of (i) a global positioning sensor or (ii) a local positioning sensor. The global positioning sensor provides a global map of the at least one rebar intersection of a work area and the local at least one positioning sensor provides a local map of the at least one rebar intersection of the work area. The processing device 108 is controlled by the control box 120. The processing device 108 (i) controls the ground-based robot or the air-based robot 102 at the work area, (ii) positions the ground-based robot or the air-based robot 102 in a coordinate frame, (iii) detects the at least one rebar intersection that have to be tied, (iv) determines if the at least one rebar intersection that are already tied, and (v) identifies the position of the at least one rebar intersection in the coordinate frame of the work area. In some embodiments, the at least one of (i) the parallel style manipulator or (ii) the serial style manipulator 110 includes a system with at least one degree of freedom. The system includes a delta arm with controls in X, Y, and Z coordinates and a linear actuator with controls in the X, Y, and Z coordinates. The at least one degree of freedom may be a rotational axis. In some embodiments, the rebar is tied using at least one of a rebar tie wire 122, or fasteners. In some embodiments, the at least one of (i) the parallel style manipulator or (ii) the serial style manipulator 110 includes a position and intersection identifying sensors 112 and a global frame of sensors 114.

In some embodiments, the at least one intersection detection sensor 104 and the intersection detection sensor 112 include a visible light camera or an infrared camera, radio frequencies, a lidar or time of flight sensor, or structure light. The at least one positioning sensor 106 and the positioning sensor 114 may include one or more of GPS (Global Positioning System), visual odometry, feature tracking, SLAM (Simultaneous Localization and Mapping) techniques, and motion capture systems using passive markers e.g. AR markers, dot patterns, QR codes, reflective spheres, reflective tape, print or various other fiducial markers, active markers, e.g. illuminated symbols, and lights, inertial systems, magnetic positioning, radio frequency triangulation, indoor GPS solutions, a Bluetooth low energy, and range and detection sensors (distance to ground). In some embodiments, the ranging and detection sensors detects at least one of a spacing to ground or rebar or other obstacles using sensors such as an ultrasonic sensor, a lidar sensor, a radar sensor, a time-of-flight, sensor, a stereoscopic sensor etc. at least one of (i) the parallel style manipulator or (ii) the serial style manipulator 110 positions the rebar tying tool 116 on the at least one rebar intersection. The linear actuator 204 may be fixed at a 0 degree of freedom or at the 4th degrees of freedom to positions the rebar tying tool 116 close to the at least one rebar intersection. The at least one of (i) the parallel style manipulator or (ii) the serial style manipulator 110 may be active or passive e.g. inherent by how the air-based robot 102 lands.

In some embodiments, the rebar tying tool 116 includes at least one of a rebar gun, a wire spool, plastic fasteners, a tie-wire reel, a rebar twist plier, an electric power tool, a Reinforcing rod binding machine, or a bar connecting apparatus. In some embodiments, the rebar size is fed to the rebar automating robot by at least one of: the air-based robot 102, a technician, or from a computer-aided design and drafting CAD model.

In some embodiments, the rebar automating robot positions a slab at the work area for automatic positioning of the rebar inside a formwork. In some embodiments, a marking tool of the rebar automating robot virtually makes visual marks of the formwork and the positioning of the rebar inside the formwork using a maker such as a paint or a chalk. In some embodiments, the visual marks of the formwork and the positioning of the rebar inside the formwork is done manually by the technician or a worker. In some embodiments, the formwork is a temporary or a permanent moulds into which concrete is poured. The linear actuator 204 or the delta arm 208 navigates the rebar automating robot to the marking of the formwork and places the rebar inside the formwork. In some embodiments, the rebar is supported by at least one bolster. In some embodiments, the formwork and the rebar are positioned at the marking by the rebar automating robot.

In some embodiments, the rebar tying tool 116 includes an automatic rebar tie wire twister. The automatic rebar tie wire twister includes a reinforced internal spring mechanism to improve overall durability. In some embodiments the automatic rebar tie wire twister further includes an automatic recoil and reload action which saves time and reduces manual labor. The fasteners may include a kodi klip. In some embodiments the kodi klip connects rebar grips tighter and faster than the rebar tie wire, dramatically reducing wracking by creating more stable rebar connections. In some embodiments, the tie-wire reel includes an aluminum alloy with wear parts made of steel.

In some embodiments, the electric power tool includes a main switch. The main switch is configured to accept an operation to switch main power from off to on and an operation to switch the main power from on to off, and its control unit may be configured to be capable of executing at least one sequence of operation in which the actuator is operated according to a predetermined sequence when the main power is on. The reinforcing rod binding machine includes a tie wire feeding mechanism which feeds a tie wire wound around a reel toward a tie wire guide nose so as to form a tie wire loop around reinforcing bars, a tie wire cutting mechanism which cuts a rear end portion of the tie wire loop to separate the tie wire loop from a succeeding tie wire, and a tie wire twisting mechanism which clamps and twists the tie wire loop. The bar connecting apparatus applies clips to connect transverse bars used in reinforced concrete.

In some embodiments, the rebar automating robot includes rebar accessories. The rebar accessories include a transverse bar assembly for use in constructing rebar mats for reinforcement of concrete paving. The transverse bar assembly includes one or more chairs and clips. In some embodiments, each chair and clip include a lower portion that fixes to a transverse bar in a direction of its length and an upper portion for orthogonally receiving and holding locked in place a longitudinal bar. In some embodiments, each chair includes a support extending to a base surface.

In some embodiments, the rebar accessories include an apparatus for fixating and elevating an interconnected rebar lattice with individual longitudinal and transverse at least one rebar intersections for use as support for poured concrete in highway and other construction. The apparatus including a holding portion include an open-ended recess with two opposing walls being generally U-shaped. The open-ended recess includes a longitudinal axis and is sized and shaped to receive a longitudinal rod.

In some embodiments, the processing device 108 includes a machine learning technology. The machine learning technology is built on a mathematical model based on a data. The data includes at least one of: a position of rebar laid, a spacing of rebar laid, tied intersections, or intersections to tie. The data is used to train the rebar automating robot in order to identify the at least one rebar intersection. In some embodiments, the processing device 108 provides details on the at least one rebar intersection using a computer vision. The computer vision is a subfield of artificial intelligence and machine learning. In some embodiments, visual odometry is used for determining a position and orientation of the rebar automating robot by analyzing an associated camera images from the one or more cameras.

In some embodiments, the rebar automating robot includes an inertial measurement unit (IMU). The inertial measurement unit (IMU) is an electronic device that measures and reports a rebar automating robot's specific force, angular rate, and an orientation of the rebar automating robot, using a combination of accelerometers, gyroscopes, and sometimes magnetometers. The rebar automating robot also includes a rotary encoder. The rotary encoder converts the angular position or motion of a shaft or axle to analog or digital output signals. In some embodiments, the rebar automating robot includes a linear encoder. The linear encoder includes at least one of a sensor, transducer or readhead paired with a scale that encodes position. The sensor reads the scale in order to convert the encoded position into an analog or digital signal, which can then be decoded into position by a digital readout (DRO) or a motion controller. The rebar automating robot also includes a servomotor. The servomotor is a rotary actuator or the linear actuator that allows for precise control of angular or linear position, velocity and acceleration. The servomotor includes a suitable motor coupled to a sensor for position feedback.

In some embodiments, the rebar automating robot includes a tracker for positioning the rebar tying tool 116 on the at least one rebar intersection. In some embodiments, the rebar automating robot effectively creates real-time movements of a three-dimensional virtual character by use of a small number of sensors. In some embodiments, the rebar automating robot includes a 3D Rebar Detailing software. The 3D Rebar Detailing software enables efficient reinforcement modeling in 3D, achieving construction-ready level of accuracy. In some embodiments, the 3D Rebar Detailing software improves the quality of detailed rebar design and documents, automatically transfer data to production and exchange information with all the project stakeholders more effectively.

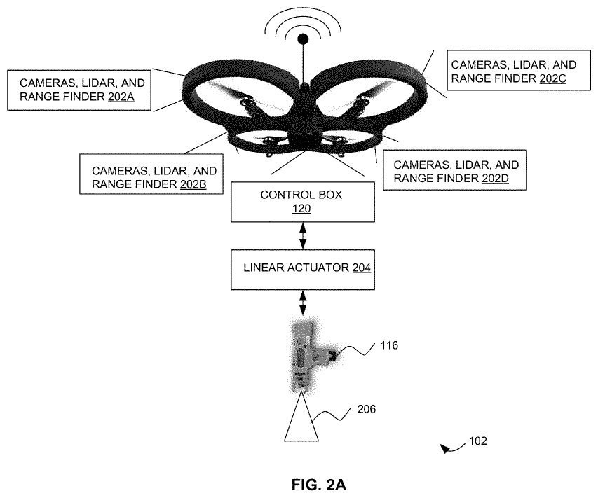

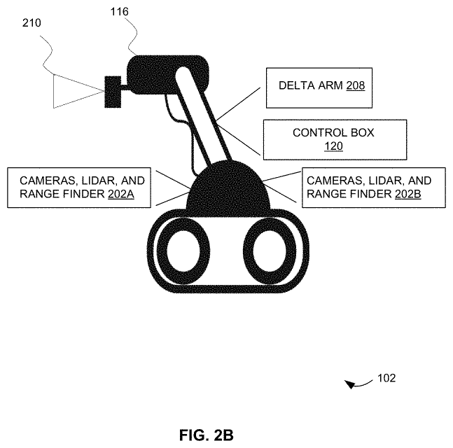

FIG. 2A is a block diagram that illustrates the air-based robot 102 for the rebar tying according to some embodiments herein. The air-based robot 102 is configured with sensors such as cameras, lidar, and range finder 202A-202D, the control box 120, a linear actuator 204, a rebar tying tool 116, and a tool position sensor 206. The cameras 202A-202D navigates, maps, avoids obstacles, and localizes the air-based robot 102. The cameras, lidar, and range finder 202A-202D provides landing or takeoff of the air-based robot 102. The cameras, lidar, and range finder 202A-202D positions the rebar tying tool 116 using the tool position sensor 206 on the at least one rebar intersection. In some embodiments, both the ground-based robot and the air-based robot 102 uses vision feedback from the sensors to land on the at least one rebar intersection. The ground-based robot and the air-based robot 102 includes an encoder for a position feedback. In some embodiments, the position feedback is feedback on distance checked with a range on the rebar tying tool 116. The air-based robot 102 extends once drone has landed or ground vehicle is parked. The control box 120 measures a rebar offset to move the rebar tying tool 116 up and down from a storage to rebar height. The rebar offset from the at least one rebar intersection is found with sensors. In some embodiments, the rebar automating robot includes an encoder, a stepper or methods for repeatable positioning to move the rebar tying tool 116 down to approximate height of the at least one rebar intersection. In some embodiments, the control box 120 maps global coordinates to ground-based robot coordinates.

FIG. 2B is a block diagram that illustrates the ground-based robot for the rebar tying according to some embodiments herein. The ground-based robot 102 is configured with sensors such as cameras, lidar, and range finder 202A-202D, the control box 120, a delta arm 208, the rebar tying tool 116, and a tool position sensor 210. The cameras 202A-202D navigates, maps, avoids obstacles, and localizes the aerial robot 102. The range finder and camera 202A-202D provides landing or takeoff of the aerial robot 102. The range finder and camera 202A-202D also positions the rebar tying tool 116 using the tool position sensor 210 on the at least one rebar intersection. In some embodiments, the ground-based robot and the air-based robot 102 uses vision feedback from the sensors to land on the at least one rebar intersection.

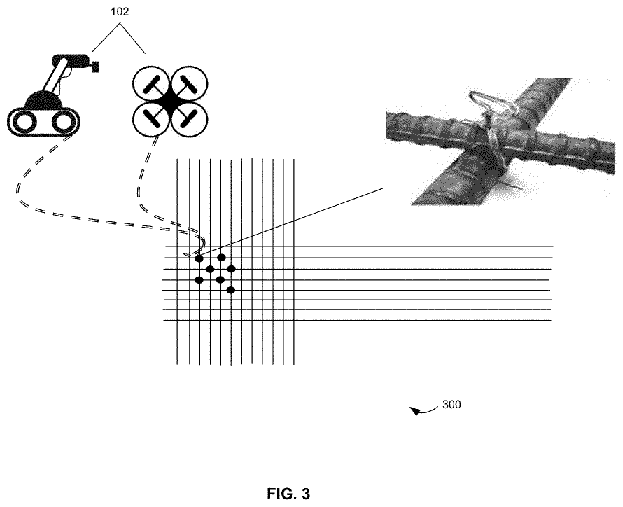

FIG. 3 illustrates an exemplary view 300 of the ground-based robot or the air-based robot 102 for identifying the at least one rebar intersection to tie and tying the identified at least one rebar intersection according to some embodiments herein. In some embodiments, the ground-based robot or the air-based robot 102 performs one or more types of tying that may include a snap or simple tie, a saddle tie, a wall tie, a saddle tie with a twist, a double strand single tie and a cross tie or a figure-eight tie. The exemplary view shows the saddle tie and the figure-eight tie. The saddle tie is used for tying of footing bars or other mats to hold hooked ends of bars in position. The saddle tie is also used for securing column ties to vertical bars. The figure-eight tie helps to hold perpendicular bars tightly together while helping to prevent the bars from racking, or moving diagonally.

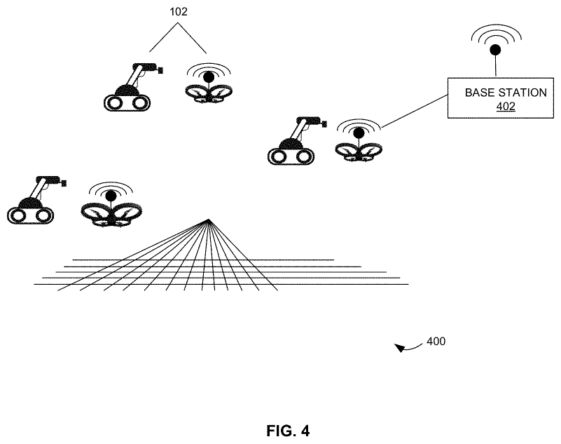

FIG. 4 illustrates an exemplary view 400 of the ground-based robot or the air-based robot 102 tying the at least one rebar intersection according to some embodiments herein. The an exemplary view 400 shows how the ground-based robot or the air-based robot 102 communicates with a base station 402 through e.g a wireless communication link. In some embodiments, one or more robots are used to scale up and do the rebar tying process faster. The base station 402 may conduct world navigation, manage one or more robots to map complete the work area. The base station 402 manages fleet for maintenance scheduling, gives priority to the rebar automating robot failures such as a low battery or a battery swap limit number of robots needing new battery at any one time, alerts operators of needed actions or interventions, work zone management, assigns zones to mobile robots to work in, builds a list of intersections to tie and sends to each robot, routing planning, selects safe paths for mobile robots to travel to and from zones, compares planned paths among mobile robots for collision risks, and maximizes scheduling to limit fleet down time for battery swapping or charging, tie refills, and moves between ties.

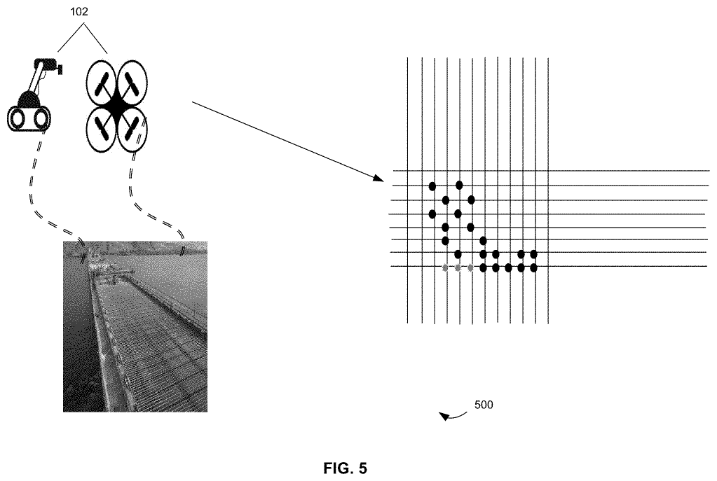

FIG. 5 illustrates an exemplary view 500 of the ground-based robot or the air-based robot 102 for identifying rebar geometry according to some embodiments herein. The ground-based robot or the air-based robot 102 moves over the rebar to generate and identify a data. The data includes a position of rebar laid, a spacing of rebar laid, tied intersections, or intersections to tie. The grey circles represent areas flagged for a user input. The user input is obtained when there is difficulty in identifying a hard intersection by the rebar automating robot e.g. if the ground-based robot or the air-based robot 102 faces the challenge of not finding the at least one rebar intersection or the rebar is tied or untied intersection, improper spacing, wrong rebar size used, missing splice ties, and not enough overlap on a splice or overlaps not touching.

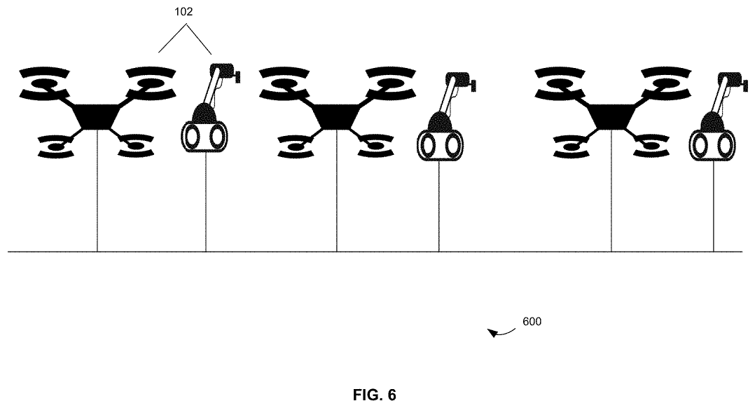

FIG. 6 illustrates an exemplary view 600 of the rebar by the ground-based robot or the air-based robot 102 according to some embodiments herein. One or more ground-based robots or the air-based robots picks up and places the rebar with slung loads or where the rebar is rigidly attached to robot's frame or structure, or a combination across a fleet. The rigid may be with grippers, magnets, clamps, kinematic couplings, hooks, or other passive components and any combination thereof. In some embodiments, a slung load maybe attached to the rebar automating robot.

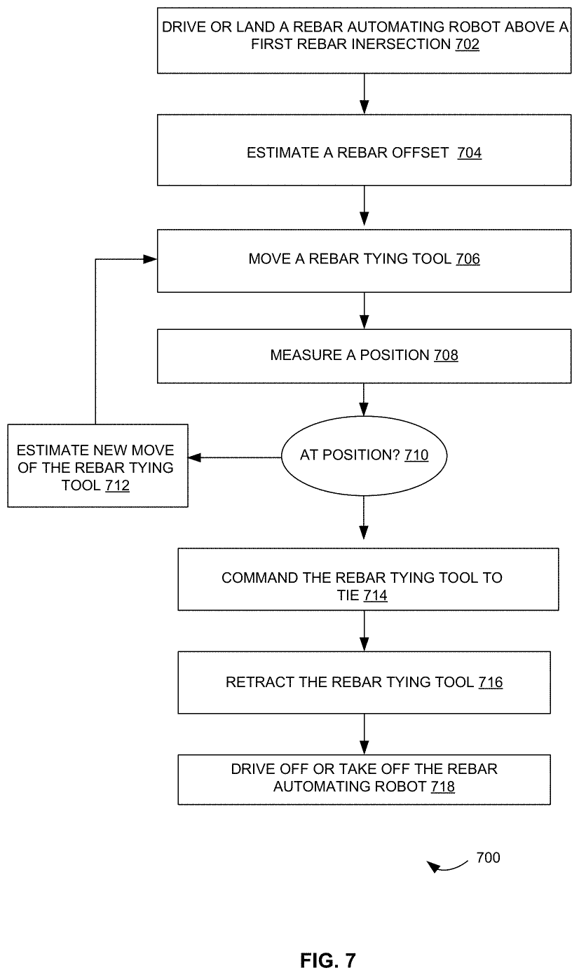

FIG. 7 is a flow diagram 700 that illustrates a method for tying a rebar according to some embodiments herein. At step 702, the method 700 includes driving or landing the rebar automating robot above a first rebar intersection. At step 704, the method 700 includes estimating a rebar offset by scanning the work area using the rebar automating robot. At step 706, the method 700 includes moving the rebar tying tool 116 to the first rebar intersection. At step 708, the method 700 includes measuring a position where rebar tying is performed. At step 710, the method 700 includes checking if the rebar tying tool 116 is at the position. At step 712, the method 700 includes estimating a new move for the rebar automating robot by scanning the work area. At step 714, the method 700 includes commanding the rebar tying tool 116 to tie the first rebar intersection. At step 716, the method 700 includes retracting the rebar tying tool 116 if the first rebar intersection is tied. At step 718, the method 700 includes driving off or taking off the rebar automating robot from the first rebar intersection.

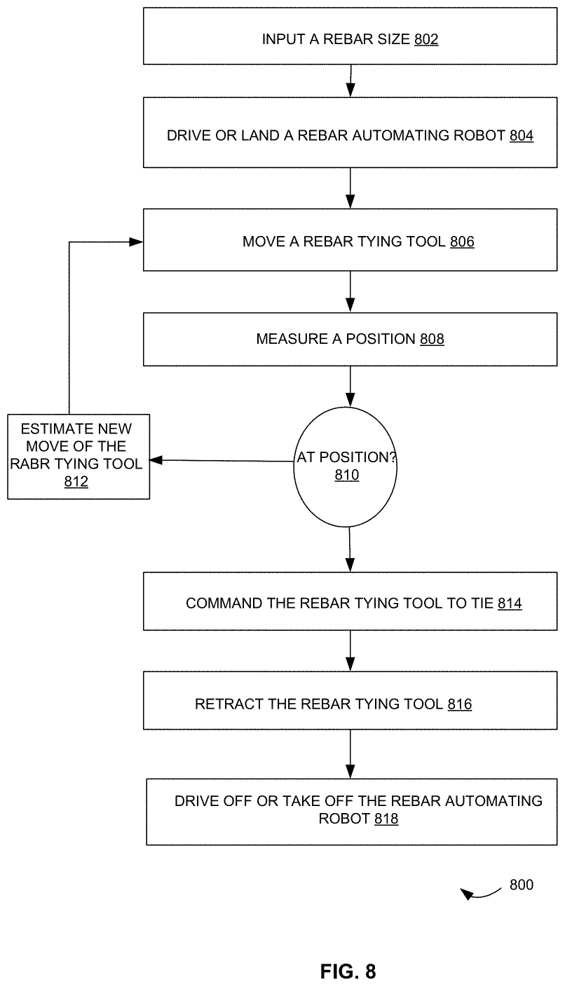

FIG. 8 is a flow diagram that illustrates a method 800 of determining the rebar size and the rebar offset based for tying the rebar according to some embodiments herein. At step 802, the method 800 includes inputting a rebar size to the rebar automating robot. The rebar size is inputted to the rebar automating robot by at least one of: the air-based robot 102, a technician, or from a computer-aided design and drafting CAD model. At step 804, the method 800 includes driving or landing the rebar automating robot above the first rebar intersection. At step 806, the method 800 includes moving the rebar tying tool 116 to the first rebar intersection. At step 808, the method 800 includes measuring a position where rebar tying is performed. At step 810, the method 800 includes checking if the rebar tying tool 116 is at the position. At step 812, the method 800 includes estimating a new move for the rebar automating robot. At step 814, the method 800 includes commanding the rebar tying tool 116 to tie the first rebar intersection. At step 816, the method 800 includes retracting the rebar tying tool 116 if the first rebar intersection is tied. At step 818, the method 800 includes driving off or taking off the rebar automating robot from the first rebar intersection.

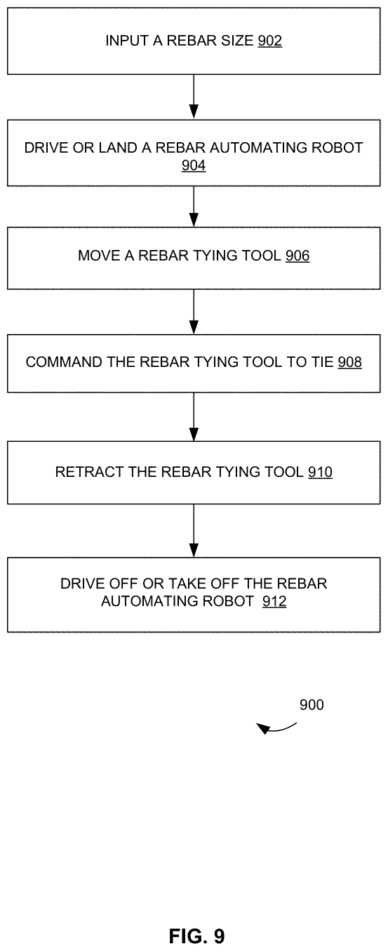

FIG. 9 is a flow diagram that illustrates a method 900 for determining the rebar size and the rebar offsets and commanding the tying rebar tool to tie the first rebar intersection according to some embodiments herein. At step 902, the method 900 includes inputting a rebar size to the rebar automating robot. The rebar size is inputted to the rebar automating robot by at least one of: the air-based robot 102, a technician, or from a computer-aided design and drafting CAD model. At step 904, the method 900 includes driving or landing the rebar automating robot above the first rebar intersection. At step 906, the method 900 includes moving the rebar tying tool 116 to the first rebar intersection. At step 908, the method 900 includes commanding the rebar tying tool 116 to tie the first rebar intersection. At step 910, the method 900 includes retracting the rebar tying tool 116 if the first rebar intersection is tied. At step 912, the method 900 includes driving off or taking off the rebar automating robot from the first rebar intersection.

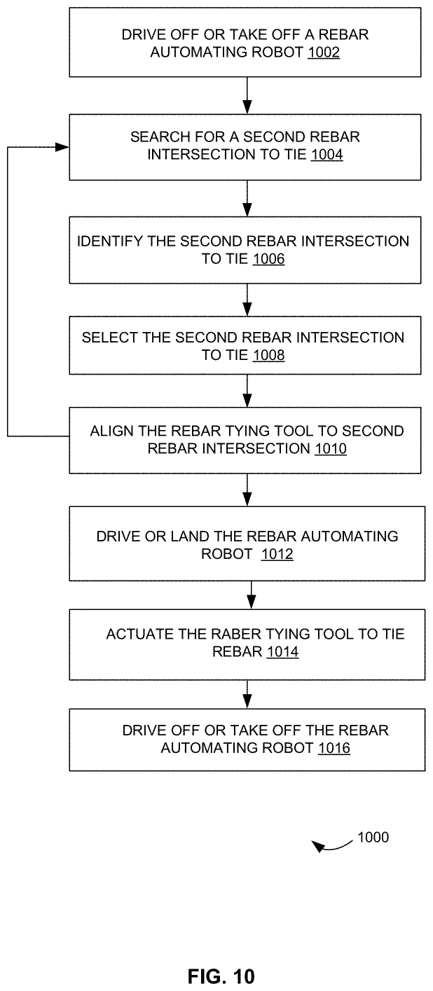

FIG. 10 is a flow diagram that illustrates a method for aligning the rebar tying tool a second rebar intersection according to some embodiments herein. At step 1002, the method 1000 includes driving off or taking off the rebar automating robot from the first rebar intersection. At step 1004, the method 1000 includes searching by the rebar automating robot for a second rebar intersection to tie. At step 1006, the method 1000 includes identifying the second rebar intersection with lidar scanning looking for rebar peaks to build a target plane to tie. At step 1008, the method 1000 includes selecting the second rebar intersection to tie. At step 1010, the method 1000 includes aligning the rebar tying tool 116 on the second rebar intersection. At step 1012, the method 1000 includes driving or landing the rebar automating robot at the second rebar intersection. At step 1014, the method 1000 includes aligning the rebar tying tool 116 on the second rebar intersection for tying the second rebar intersection. At step 1016, the method 1000 includes driving off or taking off the rebar automating robot from the second rebar intersection.

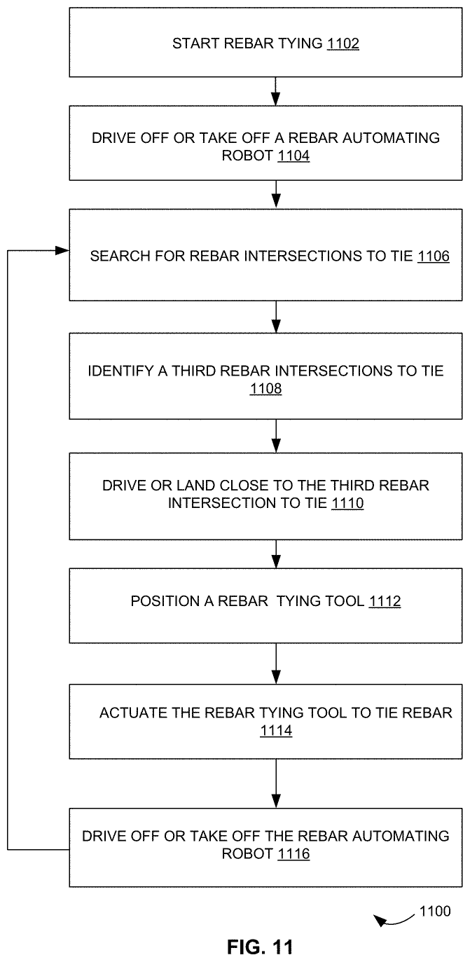

FIG. 11 is a flow diagram that illustrates a method 1100 for automating the rebar according to some embodiments herein. At step 1102, the method 1100 includes starting the rebar tying. At step 1104, the method 1100 includes driving off or taking off the rebar automating robot from the second rebar intersection. At step 1106, the method 1100 includes searching for a third rebar intersection to tie. At step 1108, the method 1100 identifying the third rebar intersection to tie. At step 1110, the method 1100 includes driving or landing the rebar automating robot close to the third rebar intersection to tie the rebar at the third rebar intersection. At step 1114, the method 1100 includes actuating the rebar tying tool 116 to tie. At step 1116, the method 1100 includes driving off or taking off the rebar automating robot from the third rebar intersection.

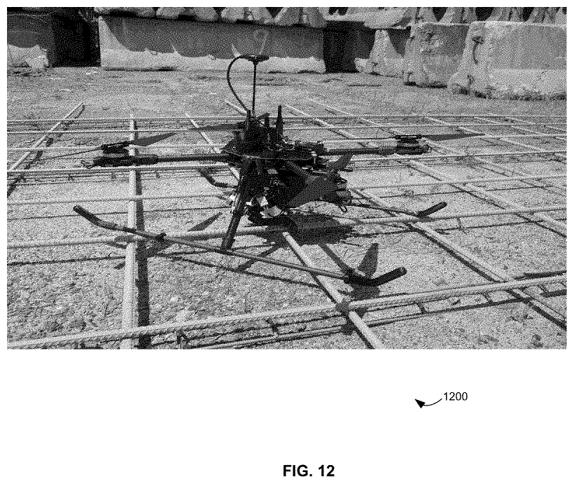

FIG. 12 illustrates the air-based robot 102 on the first rebar intersection according to some embodiments herein. After tying the first rebar intersection, the air-based robot 102 identifies an untied rebar intersection which has to be tied.

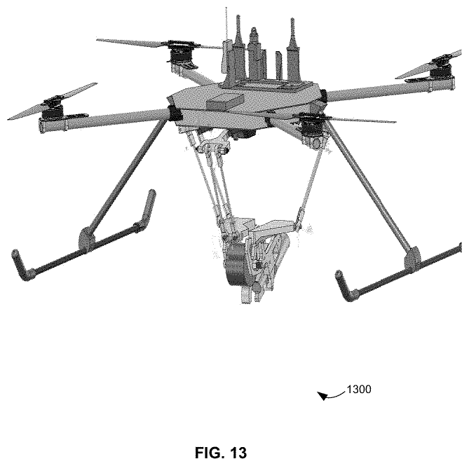

FIG. 13 illustrates a front view 1300 of the air-based robot according to some embodiments herein. The front view 1300 includes the rebar tying tool 116.

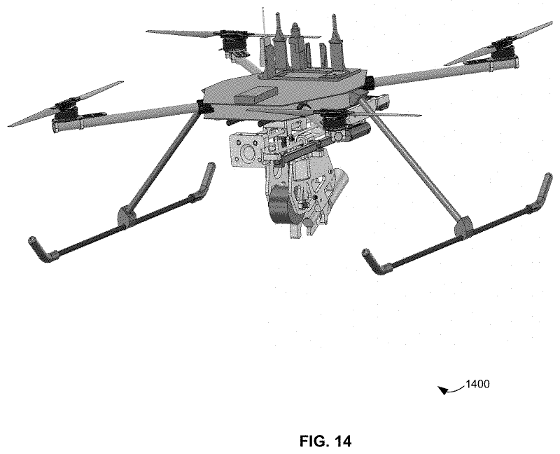

FIG. 14 illustrates a back view 1400 of the air-based robot according to some embodiments herein. The back view 1400 shows the linear actuator 204. The air-based robot 102 is navigated to the at least one rebar intersection using the linear actuator 204.

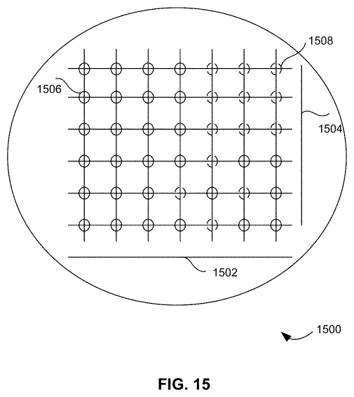

FIG. 15 illustrates an X and Y coordinates of the work area 1500 according to some embodiments herein. The X 1502 and the Y 1504 coordinates of a work area 1500 provides positioning of the rebar and the tying of the at least one rebar intersection. In some embodiments, tied rebar intersections are shown in a form of cycles 1506 and the untied rebar intersections are shown in a form of dotted cycles 1508.

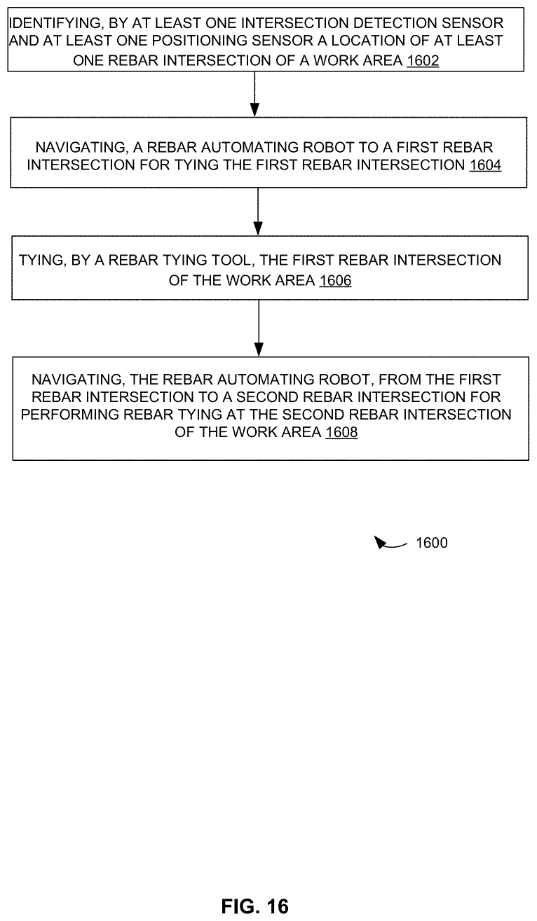

FIG. 16 illustrates a rebar automating robot controlled method 1600 for automatic rebar tying on at least one rebar intersection according to some embodiments herein. At step 1602, the method 1600 includes identifying, by at least one intersection detection sensor 104 and at least one positioning sensor 106, a location of the at least one rebar intersection of a work area. At step 1604, the method 1600 includes navigating, the rebar automating robot to a first rebar intersection for tying the first rebar intersection. At step 1606, the method 1600 includes tying, by a rebar tying tool 116, the first rebar intersection of the work area. At step 1608, the method 1600 includes navigating, the rebar automating robot, from the first rebar intersection to a second rebar intersection for performing rebar tying at the second rebar intersection of the work area.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A rebar automating robot for rebar tying at at least one rebar intersection, the rebar automating robot comprising:
a control box comprising at least one intersection detection sensor and at least one positioning sensor,
wherein the at least one intersection detection sensor and the at least one positioning sensor identifies a location of the at least one rebar intersection of a work area; and
a processing device that is controlled by the control box to perform a method of the rebar tying at the at least one rebar intersection, the method comprising:
navigating, the rebar automating robot to a first rebar intersection for tying the first rebar intersection;
tying, by a rebar tying tool, the first rebar intersection of the work area; and
navigating, the rebar automating robot, from the first rebar intersection to a second rebar intersection for performing rebar tying at the second rebar intersection of the work area.

2. The rebar automating robot of claim 1, wherein the method comprises
moving, by at least one of (i) a parallel style manipulator or (ii) a serial style manipulator, the rebar tying tool at the first rebar intersection; and
tying, by the rebar tying tool, the first rebar intersection of the work area.

3. The rebar automating robot of claim 2, wherein the parallel style manipulator comprises X, Y, and Z coordinates.

4. The rebar automating robot of claim 2, wherein the serial style manipulator comprises the X, Y, and Z coordinates.

5. The rebar automating robot of claim 2, wherein the at least one of (i) the parallel style manipulator or (ii) the serial style manipulator comprises a system with at least one degree of freedom.

6. The rebar automating robot of claim 1, wherein the at least one of (i) the parallel style manipulator or (ii) the serial style manipulator positions the rebar tying tool with the at least one rebar intersection.

7. The rebar automating robot of claim 1, wherein the processing device analyzes a data for navigating the rebar automating robot to the at least one rebar intersection, wherein the data comprises at least one of a position of rebar laid, a spacing of rebar laid, tied intersections, and intersections to tie.

8. The rebar automating robot of claim 1, wherein the rebar tying tool comprises at least one of a rebar gun, a wire spool, plastic fasteners, a tie-wire reel, a rebar twist plier, an electric power tool, a Reinforcing rod binding machine, or a bar connecting apparatus.

9. The rebar automating robot of claim 1, wherein the rebar automating robot comprises a ground-based robot or an air-based robot.

10. The rebar automating robot of claim 1, wherein the method comprises inputting, a rebar size to the rebar automating robot by at least one of: the air-based robot, a technician, or from a computer-aided design and drafting CAD model.

11. The rebar automating robot of claim 1, wherein the method comprises combining the rebar size and the data for determining untied and tied rebar intersections, for performing the rebar tying of an untied rebar intersection.

12. A rebar automating robot controlled method for rebar tying at at least one rebar intersection, the rebar automating robot controlled method comprising:
identifying, by at least one intersection detection sensor and at least one positioning sensor a location of the at least one rebar intersection of a work area;
navigating, the rebar automating robot to a first rebar intersection for tying the first rebar intersection;
tying, by a rebar tying tool, the first rebar intersection of the work area; and
navigating, the rebar automating robot, from the first rebar intersection to a second rebar intersection for performing rebar tying at the second rebar intersection of the work area.

13. The method of claim 12, wherein the method comprises
moving, by at least one of (i) a parallel style manipulator or (ii) a serial style manipulator, the rebar tying tool at the first rebar intersection; and
tying, by the rebar tying tool, the first rebar intersection of the work area.

14. The method of claim 13, wherein the parallel style manipulator comprises X, Y, and Z coordinates.

15. The method of claim 13, wherein the serial style manipulator the X, Y, and Z coordinates.

16. The method of claim 13, wherein the at least one of (i) the parallel style manipulator or (ii) the serial style manipulator comprises a system with at least one degree of freedom.

17. The method of claim 12, wherein the method comprises analyzing a data for navigating the rebar automating robot to the at least one rebar intersection, wherein the data comprises at least one of: a position of rebar laid, a spacing of rebar laid, tied intersections, or intersections to tie.

18. The method of claim 12, wherein the method comprises inputting, a rebar size to the rebar automating robot by at least one of: the air-based robot, a technician, or from a computer-aided design and drafting CAD model.

19. The method of claim 12, wherein the method comprises combining the rebar size and the data for determining untied and tied rebar intersections, for performing the rebar tying of an untied rebar intersection.
